(19) United States
(12) Patent Application Publication
(10) Pub. No.: US 2005/0231324 A1
(43) Pub. Date: Oct. 20, 2005

(54) System and method for converting message type

(75) Inventor: Min Hyun Song, Seoul (KR)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Curitel Communications, Inc.

(21) Appl. No.: 11/083,892

(22) Filed: Mar. 18, 2005

(30) Foreign Application Priority Data
Mar. 31, 2004 (KR) 10-2004-0022268

(51) Int. Cl. H04Q 7/00

(52) U.S. Cl. 340/7.56; 455/466; 340/7.53; 345/467

(57) ABSTRACT

The present invention relates to a system and a method for converting message type, and more particularly to a system and a method for converting message type of short messages in a mobile communication terminal that analyzes a character string of a received text type short message and displays an image corresponding to the analyzed character string. The system for converting message type comprises: a receiving unit for receiving a text type short message; an analyzing unit for analyzing a character string of the received short message; a storing unit having more than one character strings and images corresponding to each of the character strings; and a converting unit for searching the storing unit for a character string identical with the character string of the received short message and replacing the character string of the received short message with image corresponding to the character string in the storing unit.

### CROSS-REFERENCE TO RELATED APPLICATION

The present application is claiming priority of Korean Patent Application No. 10-2004-0022268, filed on Mar. 31, 2004, the content of which is incorporated herein by reference.

### BACKGROUND OF THE PRESENT INVENTION

1. Field of the Present Invention

The present invention relates to a system and a method for converting message type, and more particularly to a system and a method for converting message type of short messages in a mobile communication terminal that analyzes a character string of a received text type short message and displays an image corresponding to the analyzed character string.

2. Description of the Related Art

Generally, a short message service is a kind of interactive data radio paging services conforming to a global system for mobile communication (GSM) standards, which is able to transmit data between mobile communication terminals at a maximum rate of 150 bytes. Through such a short message service, it is possible to exchange messages consisting of characters and numbers between mobile communication terminals or networks. Meanwhile, services associated with the short message include a short message transmission, an emergency message display, a record of a date and time and a message acknowledge, etc.

The short message is generally a text type data. If a received short message can be converted into an image type, which can cause a visual aesthetic sense, and displayed, it is possible to obtain a user's good feeling and thus to contribute to the increase of demand.

However, a mobile communication terminal according to the related art simply displays a received text type short message as it is and does not have a function of converting the text type short message into an image type.

Accordingly, it is needed to develop a system capable of converting a text type short message into an image type and then displaying it.

### SUMMARY OF THE PRESENT INVENTION

Accordingly, the present invention has been made to solve the above-mentioned problems occurring in the prior art. The object of the present invention is to provide a system and a method in a mobile communication terminal that analyzes a character string of a received text type short message and displays an image corresponding to the analyzed character string.

In order to accomplish the objects, there is provided a system for converting message type comprising: a receiving unit for receiving a text type short message; an analyzing unit for analyzing a character string of the received short message; a storing unit having more than one character strings and images corresponding to each of the character strings; and a converting unit for searching the storing unit for a character string identical with the character string of the received short message and replacing the character string of the received short message with image corresponding to the character string in the storing unit identical with the character string of the short message.

Preferably, the system may further comprise a displaying unit for displaying the short message with the image.

Preferably, the character strings may correspond to the images respectively through an image mapping table comprising a character string field and an image field.

Preferably, American standard code for information interchange (ASCII) of the character string may be recorded in the character string field and address of memory area storing image corresponding to the character string of the character string field may be recorded in the image field.

Preferably, the converting unit may maintain the short message as text type, if the storing unit has no character string identical with the character string of the short message.

Preferably, the image stored in the storing unit may comprise a character string corresponding to the character string of the received short message.

In order to accomplish the objects, there is provided a mobile communication terminal comprising a system for converting message type, wherein the system comprises: a receiving unit for receiving a text type short message; an analyzing unit for analyzing a character string of the received short message; a storing unit having more than one character strings and images corresponding to each of the character strings; and a converting unit for searching the storing unit for a character string identical with the character string of the received short message and replacing the character string of the received short message with image corresponding to the character string in the storing unit identical with the character string of the short message.

Differently, in order to accomplish the objects, there is provided a method for converting message type comprising: receiving a text type short message; analyzing a character string of the received short message; searching a storing unit for a character string identical with the character string of the received short message; and replacing the character string of the received short message with image corresponding to the character string in the storing unit identical with the character string of the short message, if the storing unit has a character string identical with the character string of the short message.

Preferably, the method may further comprise displaying the short message with the image.

Preferably, the character string identical with the character string of the received short message may be searched by comparing ASCII of the character string of the received short message with ASCII of the character string stored in the storing unit.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing a system for converting message type according to an embodiment of the present invention;

FIG. 2 shows an image mapping table according to an embodiment of the present invention;

FIG. 3 is a view illustrating an example of converting a text type short message into an image type; and

FIG. 4 is a flow chart showing a method for converting message type according to an embodiment of the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will not be presented when it may make the subject matter of the present invention rather unclear.

FIG. 1 is a view showing a system for converting message type according to an embodiment of the present invention. As shown in FIG. 1, the system includes a receiving unit 10, an analyzing unit 20, a storing unit 30, a converting unit 40 and a displaying unit 50.

The receiving unit 10 receives a text type short message transmitted from a short message service center (not shown).

The analyzing unit 20 analyzes character strings constituting the short message. Information on the analyzed character strings (e.g. American standard code for information interchange (ASCII) corresponding to the analyzed character strings) is stored in the storing unit 30.

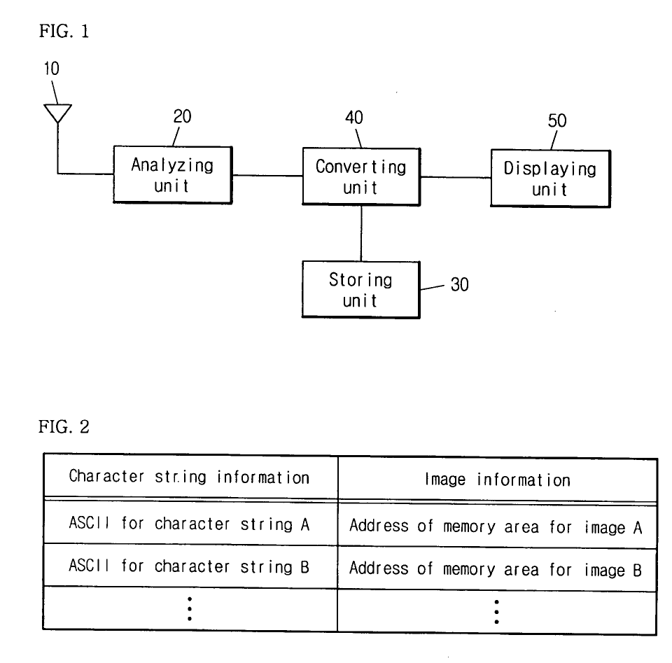

More than one character strings and images corresponding to the character strings are stored in the storing unit 30. The character strings stored in the storing unit corresponds to each of the images stored in the storing unit respectively through an image mapping table shown in FIG. 2.

In the image mapping table, information on the character strings and the images is registered as a list form. The image mapping table consists of a character string field and an image field corresponding to the character string field.

Preferably, the ASCII of the character string is recorded in the character string field and address of memory area storing image corresponding to the character string of the character string field is recorded in the image field.

The converting unit 40 searches the storing unit for a character string identical with the character string of the short message. In case the storing unit has a character string identical with the character string of the short message as a result of searching, the converting unit replaces the character string of the short message with image stored in the storing unit corresponding to the character string identical with the character string of the short message. The short message including the image is supplied to the displaying unit.

In case the storing unit has no character string identical with the character string of the short message as a result of searching, the corresponding short message is applied to the displaying unit without being converted.

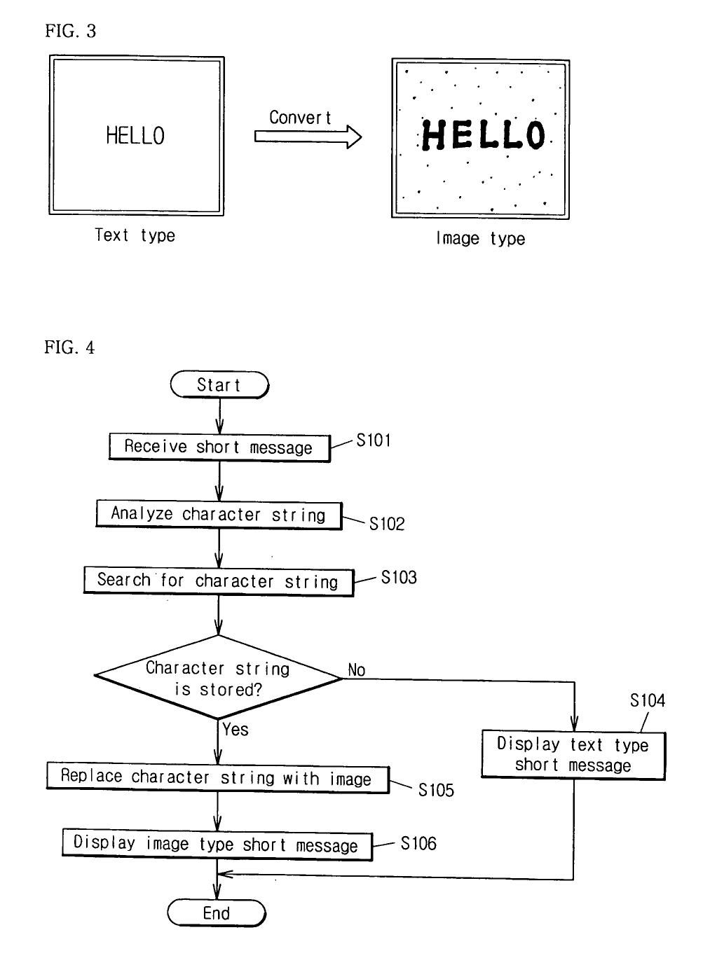

FIG. 3 is a view illustrating an example of converting a text type short message into an image type. As shown in FIG. 3, the image file comprises character strings and a background. The character strings and the background may be decorated in a specific style.

The displaying unit 50 displays the converted image type short message, or the text type short message as received.

The system for converting message type according to the present invention as described above can be applied to a mobile communication terminal.

FIG. 4 is a flow chart showing a method for converting message type according to an embodiment of the present invention.

Information on character strings of a short message to be converted into an image type and images corresponding to each of the character strings is registered in an image mapping table in a list form, and the image mapping table is stored in the storing unit 30. As described above, the information on the character strings and the images can be managed through the image mapping table comprising the character string field and the image field.

Hereinafter, a method for converting message type according to an embodiment of the present invention will be described with reference to FIG. 4.

Firstly, the receiving unit 10 of a mobile communication terminal receives a text type short message from a short message service center (not shown) (S101). The received short message is applied to the analyzing unit 20.

The analyzing unit 20 analyzes character strings of the short message (S102). Information on the analyzed character strings is applied to the converting unit. For example, as shown in FIG. 3, if the character string of the received short message is ‘Hello’, the information on the character string is analyzed in the analyzing unit 20 and then applied to the converting unit 40.

When the converting unit 40 receives the information on the analyzed character string, the converting unit 40 searches the storing unit for a character string identical with the analyzed character string by comparing ASCII for the character string of the short message with ASCII stored in the storing unit (S103).

As a result of searching, if a character string identical with the analyzed character string does not exist, the short message is applied to the displaying unit without being converted, and the displaying unit displays the text type short message as it is (S104). In other words, in the example shown in FIG. 3, if an image corresponding to the analyzed character string ‘Hello’ does not exist, the character string ‘Hello’, which is a text type short message, is displayed as it is through the displaying unit 50.

On the other hand, as a result of searching, if a character string identical with the analyzed character string exists, the converting unit 40 converts the text type short message into an image type short message by replacing the character string of the received short message with image corresponding to the character string in the storing unit identical with the character string of the short message (S105). The converted image type short message is displayed through the displaying unit 50. In other words, in the example shown in FIG. 3, if an image corresponding to the analyzed character string ‘Hello’ exists, the character string ‘Hello’, which is a text type short message, is converted into an image type by the converting unit 40 and then displayed through the displaying unit 50.

As described above, according to the present invention, when a mobile communication terminal receives a text type short message, it analyzes a character string of the received short message and replaces the character string with image corresponding to a character string in a storing unit identical with the character string of the short message, so that the text type short message can be displayed in a form of more decorated and ornamented image type. Accordingly, it is possible to obtain a user's good feeling and thus to contribute to the increase of demand.

While the present invention has been shown and described with reference to certain preferred embodiments thereof, it will be understood by those skilled in the art that various changes in form and details may be made therein without departing from the spirit and scope of the present invention as defined by the appended claims.

1. A system for converting message type comprising:
a receiving unit for receiving a text type short message;
an analyzing unit for analyzing a character string of the received short message;
a storing unit having more than one character strings and images corresponding to each of the character strings; and
a converting unit for searching the storing unit for a character string identical with the character string of the received short message and replacing the character string of the received short message with image corresponding to the character string in the storing unit identical with the character string of the short message.

2. The system according to claim 1, further comprising a displaying unit for displaying the short message with the image.

3. The system according to claim 1, wherein the character strings correspond to the images respectively through an image mapping table comprising a character string field and an image field.

4. The system according to claim 3, wherein American standard code for information interchange (ASCII) of the character string is recorded in the character string field and address of memory area storing image corresponding to the character string of the character string field is recorded in the image field.

5. The system according to claim 1, wherein the converting unit maintains the short message as text type, if the storing unit has no character string identical with the character string of the short message.

6. The system according to claim 1, wherein the image stored in the storing unit comprises a character string corresponding to the character string of the received short message.

7. A mobile communication terminal comprising a system for converting message type, wherein the system comprises:
a receiving unit for receiving a text type short message;
an analyzing unit for analyzing a character string of the received short message;
a storing unit having more than one character strings and images corresponding to each of the character strings; and
a converting unit for searching the storing unit for a character string identical with the character string of the received short message and replacing the character string of the received short message with image corresponding to the character string in the storing unit identical with the character string of the short message.

8. A method for converting message type comprising:
receiving a text type short message;
analyzing a character string of the received short message;
searching a storing unit for a character string identical with the character string of the received short message; and
replacing the character string of the received short message with image corresponding to the character string in the storing unit identical with the character string of the short message, if the storing unit has a character string identical with the character string of the short message.

9. The method according to claim 8, further comprising displaying the short message with the image.

10. The method according to claim 8, wherein the character string identical with the character string of the received short message is searched by comparing ASCII of the character string of the received short message with ASCII of the character string stored in the storing unit.
